(19) United States
(12) Patent Application Publication
(10) Pub. No.: US 2024/0360891 A1
(43) Pub. Date: Oct. 31, 2024

(54) Gear drive mechanism with sweeping rotation in two perpendicular axes

(71) Applicant: VIETTEL GROUP, Ha Noi City (VN)

(72) Inventors: VAN TUNG NGUYEN, Ha Noi City (VN); THI HANG LE, Ha Noi City (VN); HOAI SON NGUYEN, Ha Noi City (VN); XUAN BACH LUU, Hung Ha District (VN); BAU NGUYEN, Ha Noi City (VN); TAN LONG PHAM, Hai Duong City (VN); MINH VIEN NGUYEN, Ha Noi City (VN)

(73) Assignee: VIETTEL GROUP, Ha Noi City (VN)

(21) Appl. No.: 18/404,164

(22) Filed: Jan. 4, 2024

(30) Foreign Application Priority Data
Apr. 27, 2023 (VN) 1-2023-02835

(51) Int. Cl. F16H 37/06

(52) U.S. Cl. CPC F16H 37/065

(57) ABSTRACT

A rim transmission mechanism to create a rotating motion in two axes perpendicular to devices for the purpose of detecting and monitoring the target. This is the mechanical mechanism that carries out the rotating transmission of two horizontal and vertical directions (azimuth) (azimuth). Half of half-spring gear. The structure includes the main components: horizontal channel clusters, teeth clusters and vertical channels. Location sensors, angular velocity sensors are arranged, designed scientifically, optimizing the layout space and mass of the structure.

### TECHNICAL FIELD COVERED

The present invention relates to a gear-wheel drive mechanism that generates sweep rotation in two orthogonal axes, which can be used for equipment requiring horizontal-vertical sweep rotation. Specifically, the content mentioned in the invention describes the design of a product for a gear transmission mechanism driven by an eccentric shaft system combined with ball bearings, driven by a gear pairing mechanism. double spring double halve teeth.

### TECHNICAL STATUS OF THE INVENTION

Among the patent documents and published articles, a number of works are related to two-axis drive mechanism for rotating, horizontal-vertical scanning equipment. However, the related inventions and articles still have some shortcomings or limitations, such as:

Patent U.S. Pat. No. 6,531,990 B2 “Gimbal system for satellite antennas” dated Nov. 3, 2023 describes the mechanism to rotate the antenna along the axis-azimuth. In which the guiding system uses two sets of rolling bearings that are pushed by springs, the pair of gears that mesh is a pair of straight cylindrical gears. The detailed design of the drive mechanism, the transmission mechanism, the design is completely different from the mentioned invention.

To overcome the above limitations, the authors of Viettel Aerospace Institute propose a gear transmission mechanism to create a rotational motion in two perpendicular axes for horizontal and vertical scanning devices, not like any invention ever published.

### TECHNICAL NATURE OF THE INVENTION

The purpose of the present invention is to describe in detail the design of a gear-wheel drive mechanism that generates sweeping motion in two perpendicular axes. The mechanism uses a motor combined with a double-spring double halve gear transmission to create motion, and at the same time reduce the mechanical slip of the gearing system. The use of eccentric shaft system combined with ball bearing helps to adjust the guide of the movement, the axial distance of the gear pair is precisely matched, making the system stable and quieter. In addition, the structure also optimizes the layout space of the position sensors and angular velocity sensors, making the installation easier and more convenient.

To achieve the above purpose, the authors propose the design of a gear transmission mechanism to create a sweeping rotation along two perpendicular axes, including the parts shown in the cluster in FIG. 1: horizontal channel cluster (1), gear assembly (2), and vertical channel assembly (3). In addition, the detailed parts in each assembly of the mechanism are detailed in FIG. 2.

Horizontal channel assembly (1) includes: horizontal channel transmitter frame (4), horizontal channel transmitter cover (5), motor assembly (6), double spring double halve gear assembly (7), second gear assembly double spring halves (8), double spring double halves gear assembly (9), double spring double halves gear assembly (10), double spring double halves gear assembly (11), canopy pin (12), spring (13), bearing inner ring stopper (14), bearing outer ring block (15), position sensor assembly (16).

Ring gear assembly (2) includes: gear rack (17), horizontal eccentric shaft (18), non-eccentric rotating shaft (19), bushing (20), ball bearing (21), ball bearing (22), horizontal channel roller bearing stop screw (23), shock absorber (24), horizontal channel damping holder (25), bearing inner ring stopper (26), ball bearing (27), vertical eccentric shaft (28), nut (29), vertical channel fan rack gear (30), ring gear (31), vertical channel rotation shaft (32), horizontal channel rotation stopper (33), vertical channel rotation block (34), vertical channel rotation axis (35), blocking vertical channel rotation (36).

Vertical channel assembly (3) includes: vertical channel gearbox cover (37), vertical channel gear transmission (38), vertical channel gearbox body (39), bearing outer ring block (40), rolling bearing (41), bearing inner ring stopper (42), vertical channel mount (43), vertical channel rotation stopper (44), counterweight (45), angular velocity sensor device (46).

The entire system of position sensors, angular velocity sensors, motors and auxiliary equipment are firmly fixed and protected by a mechanical structure made of aluminum alloy.

The products of the present invention can be used in scanning devices, observation and search systems.

### BRIEF DESCRIPTION OF THE DRAWINGS

FIG. 1 depicts an overview of the mechanical design.

FIG. 2 depicts the detailed dissection of the gear transmission mechanism.

FIG. 3 depicts a detailed cross-section of the drive mechanism.

FIG. 4 depicts a double spring gear halve engagement mechanism.

FIG. 5 depicts the rotation direction of the rotation axes.

FIG. 6 depicts the cross-section of the rotation directions.

FIG. 7 depicts the displacement of the ball bearing when rotating the eccentric shaft.

FIG. 8 depicts the design of the eccentric shaft.

### DETAILED DESCRIPTION OF THE INVENTION

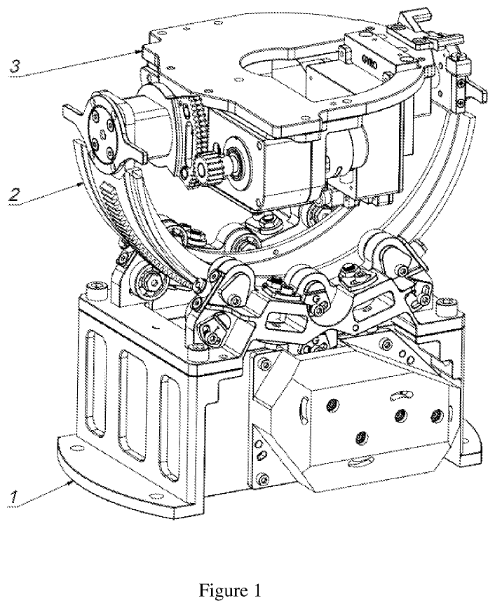

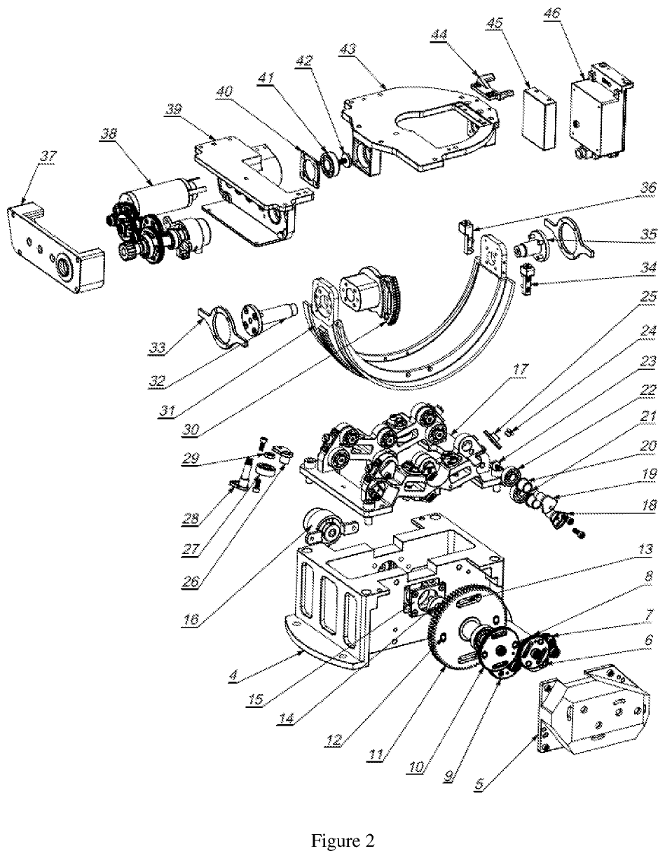

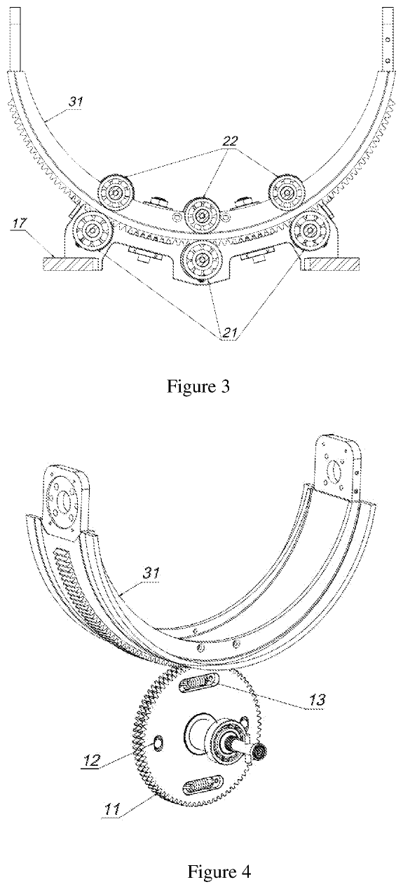

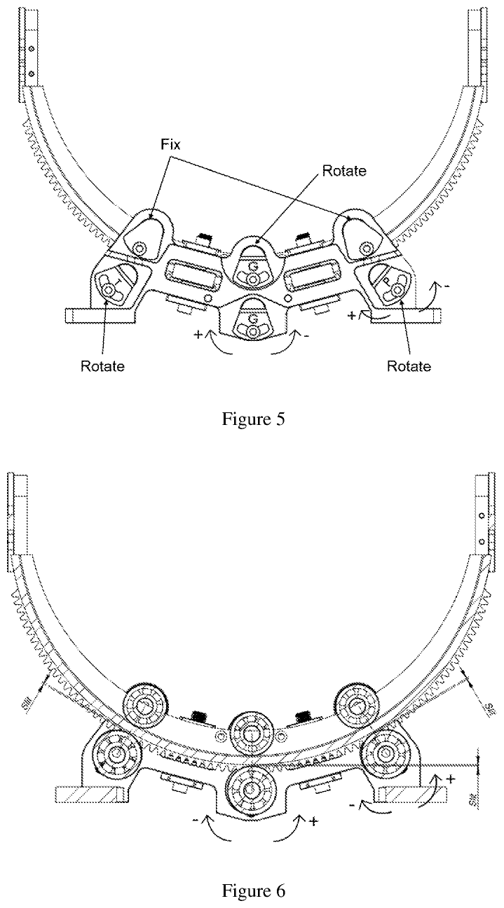

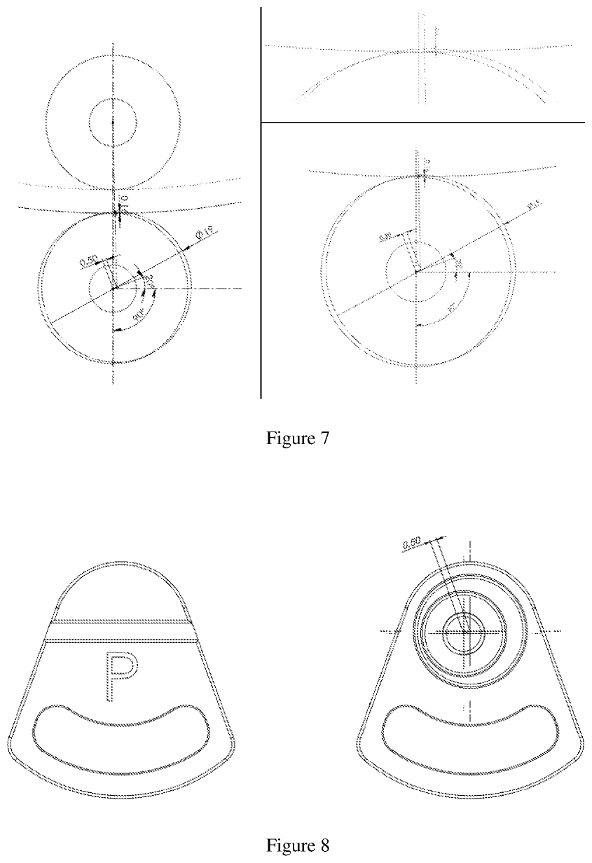

FIG. 1 describes an overview of the design of a gear transmission mechanism to create a sweeping rotation along two perpendicular axes, FIG. 2 describes and lists in detail the components of the actuator, transmission, and FIG. 3. showing the cross-section of the drive mechanism by the eccentric rotary shaft combined with the ball bearing, FIG. 4 shows the double spring gear halving mechanism.

The main equipment assemblies of the gear transmission mechanism creating sweeping rotation in 2 perpendicular axes include:

Horizontal channel cluster (1): includes mechanical components, gears, motors, position sensors that have the function of creating gear-matching motion with the gear ring assembly, controlling the mechanism to the corner positions. go out. In addition, the horizontal channel assembly is also a support for the transmission mechanism, helping to assemble the transmission assembly onto other assemblies of the device.

At each substructure, the difference is that

Horizontal channel transmission frame (4): is a mechanical part made from aluminum alloy used to mount pairs of gears, motors, position sensors.

Horizontal channel transmitter cover (5): is a mechanical part made from aluminum alloy used to mount pairs of mating gears and protect mating gear pairs from being stuck and damaged due to dirt sticking to the surface, face.

Motor assembly (6): is a brush motor, the motor shaft has stainless steel gears and is blocked by a threaded vortex nut. The tail of the engine has a position sensor installed.

Gear cluster with two halves of double spring (7): is a mechanical assembly consisting of gears, springs, rivet pins, and taper pins made from stainless steel. The pair of double spring double halves are connected together by a pin and spring, making the two halves of the gear always in a different state, helping to reduce the looseness of the gear pair during operation.

Double spring double halve gear assembly (8): is a mechanical assembly consisting of gears, springs, rivet pins, and taper pins made from stainless steel. The pair of double spring double halves are connected together by a pin and spring, making the two halves of the gear always in a different state, helping to reduce the looseness of the gear pair during operation.

Gear cluster with two halves of double spring (9): is a mechanical assembly consisting of gears, springs, rivet pins, and bevel pins made from stainless steel. The pair of double spring double halves are connected together by a pin and spring, making the two halves of the gear always in a different state, helping to reduce the looseness of the gear pair during operation.

Gear cluster with two halves of double spring (10): is a mechanical assembly consisting of gears, springs, rivet pins, and taper pins made from stainless steel. The pair of double spring double halves are connected together by a pin and spring, making the two halves of the gear always in a different state, helping to reduce the looseness of the gear pair during operation.

Double spring double halve gear assembly (11): is a mechanical assembly consisting of gears, springs, rivet pins, and taper pins made from stainless steel. The pair of double spring double halves are connected together by a pin and spring, making the two halves of the gear always in a different state, helping to reduce the looseness of the gear pair during operation.

Cantilever pin (12): is a mechanical part made from stainless steel, cylindrical with a round cap, used to fix two gear halves together.

Spring (13): is a mechanical part made from stainless steel, consisting of twisted spring rings, shaped like hooks at both ends, used to pull the two halves of gears together.

Blocking the inner ring of the bearing (14): is a mechanical part made from stainless steel, cylindrical, the inner ring is threaded to help tighten and block the inner ring of the bearing.

Block bearing outer ring (15): is a mechanical part made from aluminum alloy, the surface is treated with hard anode. Detail that blocks the outer ring of the bearing. The product has a thickness of 3 mm, used to block the outer ring of the bearing with a diameter of 22 mm.

Position sensor cluster (16): is a detailed assembly consisting of a position sensor and mounting details made from aluminum alloy. The sensor cluster is used to determine the position of the rotation angle of the gear mechanism, thereby giving appropriate control parameters, meeting the set requirements.

Ring gear assembly (2): includes mechanical parts, ball bearings, concentric rotating shaft, eccentric rotating shaft, ball bearing screw, bushing, gear ring, rotational stop, rotating shaft with guiding function the gear ring engages the gear in the transverse channel assembly. In addition, the ring gear assembly also has the effect of mounting for the vertical channel assembly.

At each substructure, the difference is that

Mounting gear (17): is a mechanical part made from aluminum alloy, designed in the form of a hole for mounting the shaft and bearing, creating a guide mechanism in contact with the tooth ring on both sides.

Horizontal eccentric shaft (18): is a mechanical part made from stainless steel, in the form of a shaft consisting of non-concentric shafts, used to mount bearings. The eccentric shaft has the effect of fine-tuning the contact between the bearing and the gear ring, creating a concentric arc with the gear ring.

Concentric rotating shaft (19): is a mechanical part made from stainless steel, has the shape of a shaft, including concentric shafts, used to mount bearings. The non-eccentric rotating shaft has the effect of creating fixed points of the arc, concentric with the gear ring.

Bearing (20): is a mechanical part made from copper material, cylindrical with rims. The main function of the part is to fit tightly with the rotating shaft, reducing friction when rotating the shaft to adjust the bearing.

Ball bearing (21): is a standard mechanical part used to create contact points with the gear ring, creating rolling motion for the gear mechanism.

Bearing (22): is a standard mechanical part used to create contact points with the gear ring, creating rolling motion for the gear mechanism.

Horizontal channel roller bearing stop screw (23): is a mechanical part made of stainless steel, which has the function of blocking the ring in the bearing, preventing the bearing from being displaced from the shaft during operation.

Shock absorber (24): is a standard mechanical part, has the function of reducing impact, limiting the rotation angle of the transmission mechanism.

Horizontal channel damper (25): is a mechanical part made from aluminum alloy, used to attach shock absorbers, limiting the stroke for the horizontal movement of the gear mechanism.

Blocking the inner ring of the bearing (26): is a mechanical part made of stainless steel, which has the effect of blocking the inner ring of the bearing, preventing the bearing from moving in the axial direction.

Bearing (27): is a standard mechanical part used to create contact points with the gear ring, creating rolling motion for the gear mechanism.

Vertical eccentric shaft (28): is a mechanical part made from stainless steel, has the form of a shaft consisting of non-concentric shafts, used to mount ball bearings. The eccentric shaft has the effect of fine-tuning the contact between the bearing and the gear ring, creating a concentric arc with the gear ring.

Nut (29): is a standard mechanical part, used to assemble with an eccentric rotating shaft, helping to prevent the ring in the bearing from moving during operation.

Vertical channel fan gear (30): is a mechanical detail including gears, springs, rivet pins, taper pins made from stainless steel. The pair of double spring double halves is designed in the form of a fan, connected by a canopy pin and a spring, making the two halves of the gear always in a state of misalignment, helping to reduce the slip of the gear pair. when operating.

Ring gear (31): is a mechanical part made from stainless steel, machined with high precision. The detail has a circular arc, the surface of which consists of teeth to match the horizontal channel cluster. The two sides of the gear ring are the guide profiles, which are finely machined to ensure roundness and high concentricity.

Vertical channel rotating shaft (32): is a mechanical part made from stainless steel, having a shaft-shaped design, used to mount gears for vertical channel fans, and at the same time creates a rotation axis for the vertical channel assembly.

Blocking horizontal channel rotation (33): is a mechanical part made from stainless steel, with a stop point design on both sides, with high rigidity to limit the stroke of the gear ring at the two edges.

Blocking the vertical channel rotation angle (34): is a mechanical assembly consisting of dampers and dampers, which helps to limit the stroke of the vertical channel assembly.

Vertical channel rotating shaft (35): is a mechanical part made from stainless steel, has an axial design, used to mount and create a rotating shaft for the vertical channel assembly.

Blocking the vertical channel rotation angle (36): is a mechanical assembly consisting of dampers and dampers, which helps to limit the stroke of the vertical channel assembly.

Vertical channel assembly (3): includes mechanical components, ball bearing, double spring double halve gear assembly, ball bearing stop screw, rotation angle blocker, counterweight, angular velocity sensor with motion generation function vertical channel scanning. In addition, the vertical channel cluster also has the effect of mounting transceiver equipment for the vertical channel cluster.

At each substructure, the difference is that

Vertical channel gearbox cover (37): is a mechanical part made of aluminum alloy, which has the effect of mounting ball bearings, ensuring the axial distance of the gear pairs, and at the same time is a protective cover for the transmission gears from dust, dirt clinging to the gear surface.

Vertical channel gear transmission (38): is a detailed assembly consisting of pairs of double-spring double halves gears that are used to create vertical sweeping rotation for the mechanism.

Vertical channel gearbox body (39): is a mechanical part made of aluminum alloy, which has the effect of mounting ball bearings, ensuring the matching axial distance of the gear pairs, and at the same time is a protective cover for the transmission. gears from dust, dirt clinging to the gear surface.

Block bearing outer ring (40): is a mechanical part made from aluminum alloy, the surface is treated with hard anode. Detail that blocks the outer ring of the bearing. The product has a thickness of 2 mm, used to block the outer ring of the bearing with a diameter of 22 mm.

Roller bearing (41): is a standard mechanical part, installed in the vertical channel fixture, helping to create rotation for the vertical channel assembly.

Block ring in the bearing (42): is a mechanical part made of stainless steel, which has the effect of blocking the ring in the bearing, avoiding axial displacement during operation.

Vertical channel mount (43): is a mechanical part made from aluminum alloy, used to mount vertical channel gearboxes and other devices such as counterweights, angular velocity sensors, transceivers.

Blocking vertical channel rotation (44): is a mechanical part made from stainless steel, with a stop point design on both sides, with high rigidity to limit the stroke of the vertical channel assembly at the two edges.

Counterweight (45): is a mechanical part made from stainless steel, used to balance the center of gravity of the vertical channel assembly, helping to balance the movement of the mechanism in both directions.

Angular velocity sensor device (46): used to measure the angular velocity of the object, thereby making appropriate adjustments during the rotation and scanning in two directions of the gear mechanism.

The transverse channel assembly (1) and the ring assembly (2) are positioned by a locating pin and connected by a bolted joint between the transverse channel transmitter frame element (4) and the gear mount (17). The ring gear assembly (2) and the vertical channel assembly (3) are linked through two vertical channel rotating shaft details (32) and (35), helping to create axial rotation for the vertical channel assembly.

According to the design of the present invention, the motor assembly (6) is controlled to generate horizontal rotation for the gear assembly through pairs of double-spring double halves, the vertical channel gear train (38) generates displacement. vertical rotation for the vertical channel assembly. Eccentric rotating shaft details, shafts and bearings help to create the direction of movement for the mechanism. Pairs of double-spring double halves generate engaged movements, which increase the accuracy of the actuator. Information about the angle value, rotational speed is sent to the position sensor (16) and angular velocity sensor (46). Based on angular feedback/angular velocity from sensors to calculate and give appropriate control parameters, meeting the requirements of the actuator.

The use of space inside the gear ring (31) to arrange the vertical channel transmitter (38), counterweight (45) and angular velocity sensor (46) helps to optimize the arrangement of space, reducing the size of the mechanism, and creating balance when moving in two directions.

The result is that the diameter size of the product depends only on the size of the ring assembly (2). The small size of the mechanism makes it easy to put into use in small-diameter rotary mechanisms.

In addition, the mechanical details are made of 6061-T6 aluminum alloy, all designed in the form of steps, with stiffeners and hardened surface by being anodized to prevent scratches, increase the aesthetics of the structure, and also help maximize optimize the volume of details. Details of gears, rotating shafts, mechanical blocks are all made from stainless steel SUS420J2, SUS304; gears are treated with surface hardening to ensure high surface hardness, helping to ensure durability, avoiding surface wear during operation.

1. A gear drive mechanism for creating a sweeping rotation along two perpendicular axes, which are different in that they include: a horizontal channel cluster, a ring gear assembly, and a vertical channel cluster, in which
the horizontal channel cluster includes:
a body and cover of a horizontal channel gearbox are used to mount a 5-speed gear transmission assembly, including pairs of double-spring double halves gears that are engaged, which reduce loss, increase accuracy of the transmission, and reduce time. the response of a transmitter when reversing the motion,
a ball bearing inner ring block is designed in a form of a shaft, threaded in an inner ring, when screwed with a gear shaft, has the effect of preventing the ball bearing from moving in an axial direction,
a position sensor assembly is mounted on the gear shaft that meshes with the ring gear assembly, helping to determine the position of the rotation angle of the gear drive mechanism;
the ring gear assembly includes:
a gear ring with block structure machined with horizontal and vertical concentric circular hole system, fitted with concentric and eccentric rotating shafts, ball bearings, used to guide the gear ring details horizontally,
a vertical channel rotating shaft, which has the effect of mounting the vertical channel assembly, creating vertical movement,
a horizontal eccentric shaft is designed as an eccentric shaft, has two steps, a head of the horizontal eccentric shaft is designed in the form of a cone, with a straight slot used to adjust rotation of the shaft clockwise or counterclockwise, helping to adjust bearing. contact with the gear ring, a pea-slotted part is used to customize a mounting position of a shaft fixing screw, another end has an internal threaded tap to install a ring stop screw in the bearing,
the concentric rotating shaft is designed in the form of a concentric shaft, with two steps, a head of the shaft is designed in the form of a cone, with a drilled bolt hole to fix a shaft position, helping to fix the bearing when in contact with the gear ring, another end has an internal threaded tap for mounting the ring stop screw in the bearing,
a horizontal channel damper, with an internal threaded tap used to attach a shock absorber, limiting travel for a horizontal movement of the gear mechanism,
a ball bearing inner ring block is designed as a shaft, a head of the shaft is designed in the form of a cone, which acts to block the inner ring of the bearing, and at the same time acts as a bushing for the eccentric rotating shaft detail when adjusting the bearing according to a vertical axis,
the vertical eccentric shaft is designed as an eccentric shaft, with two steps, a head of the shaft is designed in the form of a cone, with a straight slot used to adjust rotation of the shaft clockwise or counterclockwise, helping to adjust bearing. contact with the rim; pea slotted part for customizing the mounting position of a shaft fixing screw; another end is threaded outside the shaft to install a nut,
the vertical channel rotating shaft has an axial design, with a threaded tap at one end of the shaft used to mount a vertical channel fan gear, ball bearings, block the ring in the vertical channel, create a rotation axis for the vertical channel assembly,
the vertical channel fan gear including gears, springs, rivet pins, and bevel pins made from stainless steel, a pair of double spring double halves is designed in the form of a fan, connected by a canopy pin and a spring, making the two halves of the gear always in a state of misalignment, helping to reduce the slip of the gear pair. when operating,
the gear ring has a circular arc, the surface of which consists of teeth to match the horizontal channel cluster, two sides of the gear ring are guide profiles, which are finely machined to ensure roundness and high concentricity,
A horizontal channel rotation stop and a vertical channel rotation block are designed with stops on two sides, used to limit the stroke of the gear ring;
the vertical channel cluster includes:
a body and cover of a vertical channel transmission gearbox is used to mount the 5-speed gear transmission assembly, consisting of pairs of double-spring double halves that engage, creating vertical rotation,
a vertical channel mount is used to mount a vertical channel transmitter, vertical channel rotation stop, counterweight and angular velocity sensor device.

2. The gear drive mechanism for creating sweeping rotation in two perpendicular axes according to claim 1, in which the gear ring is driven horizontally, consisting of three ball bearings at a top; three ball bearings at a bottom and two ball bearings on left and right sides, each group of three ball bearings forming a concentric circle in contact with the ring gear, which acts to support and guide the bearing, two ball bearings on both sides also have an effect of guiding the gear ring, avoiding shifting during operation.

3. The gear drive mechanism for creating sweeping rotation in two perpendicular axes according to claim 1, in which the mechanical parts are made from aluminum alloy and stainless steel.

4. The gear drive mechanism for creating sweeping rotation along two perpendicular axes according to claim 1, in which the horizontal channel assembly and the ring gear assembly are connected by a bolt joint, the ring assembly and the vertical channel assembly are connected by a rotating shaft, through ball bearings.
